(19) United States
(12) Patent Application Publication
(10) Pub. No.: US 2010/0021223 A1
(43) Pub. Date: Jan. 28, 2010

(54) KEYBOARD SUSTAINER USED IN ELECTRONIC DEVICE

(75) Inventor: GAO-BING LEI, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION INDUSTRY CO., LTD., Tu-Cheng (TW)

(21) Appl. No.: 12/508,773

(22) Filed: Jul. 24, 2009

(30) Foreign Application Priority Data
Jul. 24, 2008 (CN) 200810021294.0

(51) Int. Cl. B41J 5/00

(52) U.S. Cl. 400/472

(57) ABSTRACT

A keyboard sustainer used in an electronic device includes a metal body having a base portion with a first sustaining surface thereon for sustaining a keyboard, and an insulative body engaged with the metal body. The insulative body defines a second sustaining surface for sustaining the keyboard. The metal body includes a plurality of retaining tabs extending from a side edge of the base portion and embedded in the insulative body by insert-molding to get a firmly engagement therebetween. The first sustaining surface is coplanar with the second sustaining surface so that the keyboard can be sustained steady without any invalid connection to the sustainer.

### BACKGROUND OF THE INVENTION

1. Field of the invention

The present invention relates to a keyboard sustainer used in an electronic device.

2. Description of Related Art

Nowadays, a sustainer made of metal piece is usually used in an electronic device such as a mobile phone to sustain the keyboard. The sustainer usually includes a metal body for sustaining the keyboard and an insulative body engaging with the metal body at a side edge thereof. The insulative body is assembled into the mobile phone and engages with a shell of the mobile phone to make the keyboard securely fixed in the mobile phone. The engagement between the insulative body and the metal body is usually in a manner of insert-molding. As we known, the insert-molding technology can provide a steady engagement between the metal body and the insulative body. During the process of insert-molding, the side edge of the insulative body needs to be formed higher than a top surface of the metal body so that the side edge of the insulative body can embrace the metal body to get a steady engagement therebetween. Said top surface of the metal body is formed to sustain the keyboard, while the insulative body which is higher than said top surface is also formed to sustain the keyboard. As a result, when the keyboard is assembled onto the sustainer, some of the key buttons probably can not get contacting with the top surface of the metal body, which may leads to invalid key buttons. This is a connatural disadvantage of the insert-molding technology. But if the insert-molding technology is not used in the engagement between the metal body and the insulative body, the engagement will be more unstable.

So it is necessary to provide a new electrical connector to solve the problems above.

### SUMMARY OF THE INVENTION

Accordingly, it is an object of the present invention to provide a keyboard sustainer which provides a steady connection with the keyboard.

In order to achieve above-mentioned object, a keyboard sustainer is provided and comprises a metal body having a base portion with a first sustaining surface thereon for sustaining a keyboard; an insulative body engaged with the metal body and defining a second sustaining surface for sustaining the keyboard; wherein said metal body includes a plurality of retaining tabs extending from a side edge of the base portion for being embedded in the insulative body, said first sustaining surface is coplanar with said second sustaining surface.

Other objects, advantages and novel features of the present invention will become more apparent from the following detailed description of the present embodiment when taken in conjunction with the accompanying drawings.

### BRIEF DESCRIPTION OF THE DRAWINGS

FIG. 1 is a perspective view of the sustainer in accordance with the present invention showing the keyboard sustained thereon;

FIG. 2 is an exploded perspective view of the sustainer of FIG. 1;

FIG. 3 is an exploded perspective view of the sustainer of FIG. 2 from a bottom view;

FIG. 4 is another perspective view of the sustainer without the keyboard; and

FIG. 5 is a cross-section view of the sustainer along V-V direction.

### DETAILED DESCRIPTION OF THE INVENTION

The present invention shall be discussed hereinafter in terms of a preferred embodiment illustrated in the accompanying drawings. In the following description, numerous specific details are set forth in order for the reader hereof to gain a thorough understanding of the present invention. It will be obvious, however, to those skilled in the art that certain well-know elements may not be shown in detail in order to unnecessarily obscure the present invention.

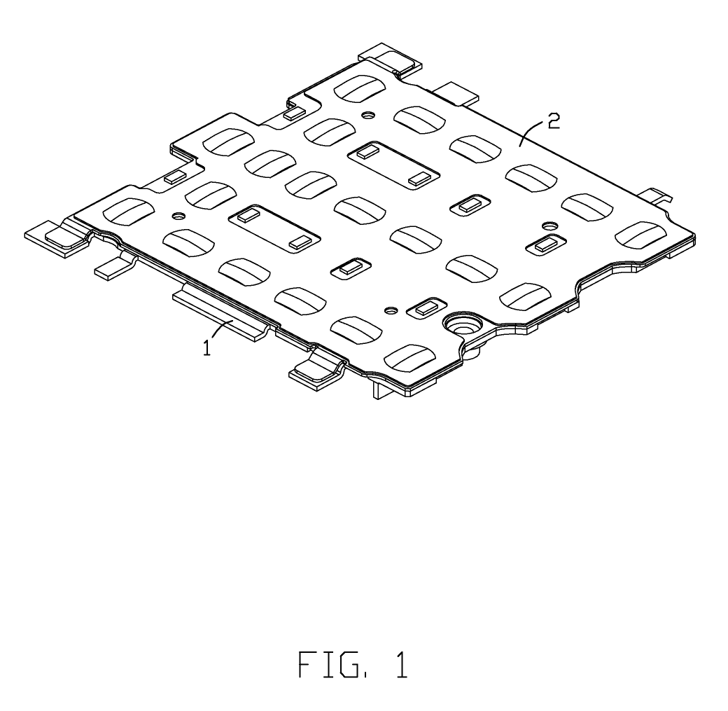

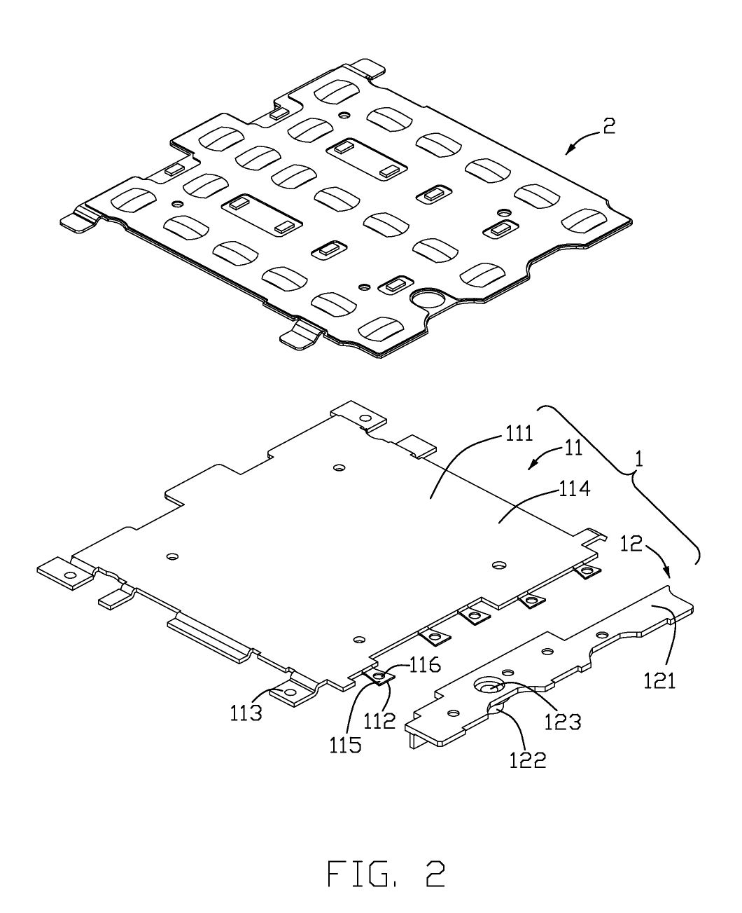

Referring to FIGS. 1 to 2, a sustainer 1 for sustaining a keyboard 2 of a mobile phone includes a metal body 11 and an insulative body 12 for engaging with said metal body 11 and a shell frame (not shown) of the mobile phone.

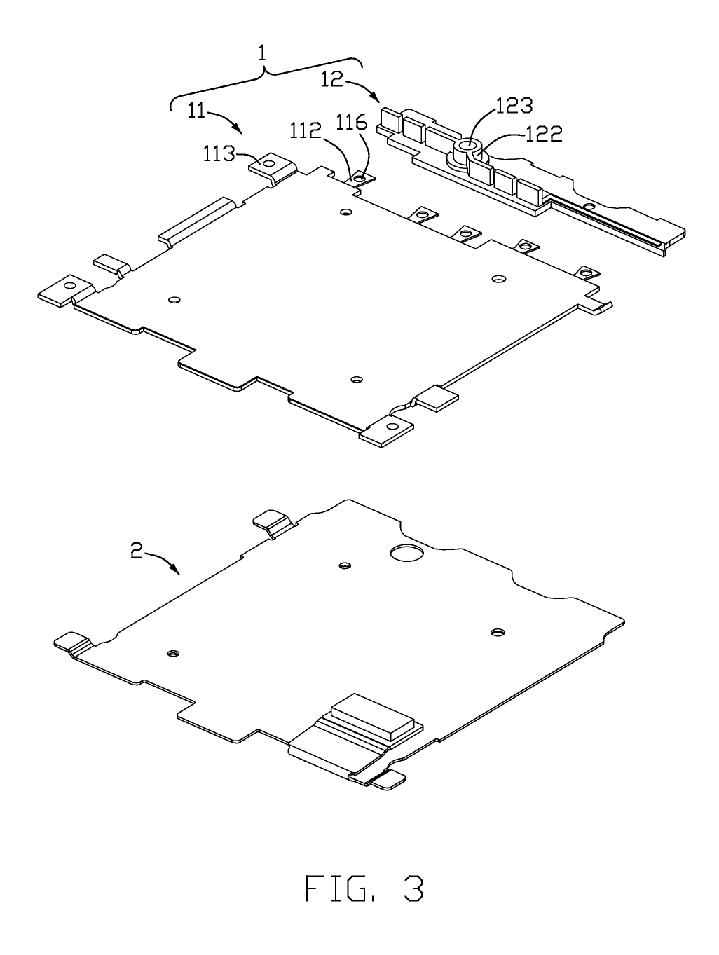

Referring to FIGS. 2 and 3, the metal body 11 is formed with a metal plate and includes a base portion 111 with a top surface sustaining said keyboard 2, a plurality of retaining tabs 112 horizontally protruding from a first side edge of the base portion 111, and a plurality of standoffs 113 bended from a lateral side of the base portion 111. Said base portion 111 has a top surface as a first sustaining surface 114 for sustaining the keyboard 2. Said retaining tab 112 extends from a lower part of the first side edge and defines a top face 115 thereon which is lower than the sustaining surface 114. Each retaining tab 112 has a retaining hole 116 running through said top surface 115. Said standoff 113 engages with the shell frame of the mobile phone in order to fix the sustainer 1 into the mobile phone firmly.

As referring to FIGS. 2 and 3, the insulative body 12 defines a top surface as a second sustaining surface 121 for sustaining the keyboard 2 and a retaining post 122 protruding downwardly from a bottom surface thereof. The second sustaining surface 121 is coplanar with said first sustaining surface 114 of the insulative body 12 so that the keyboard 2 can be sustained steady in a same plane, which makes every key button of the keyboard easy to contact with the sustaining surface 114, 121. The retaining post 122 defines a receiving groove 123 running through the second sustaining surface 121 and the bottom surface of the insulative body 12 for receiving a peg. The peg is retained in the receiving groove 123 and engages with the shell frame so that the insulative body 12 can be fixed into the mobile phone firmly.

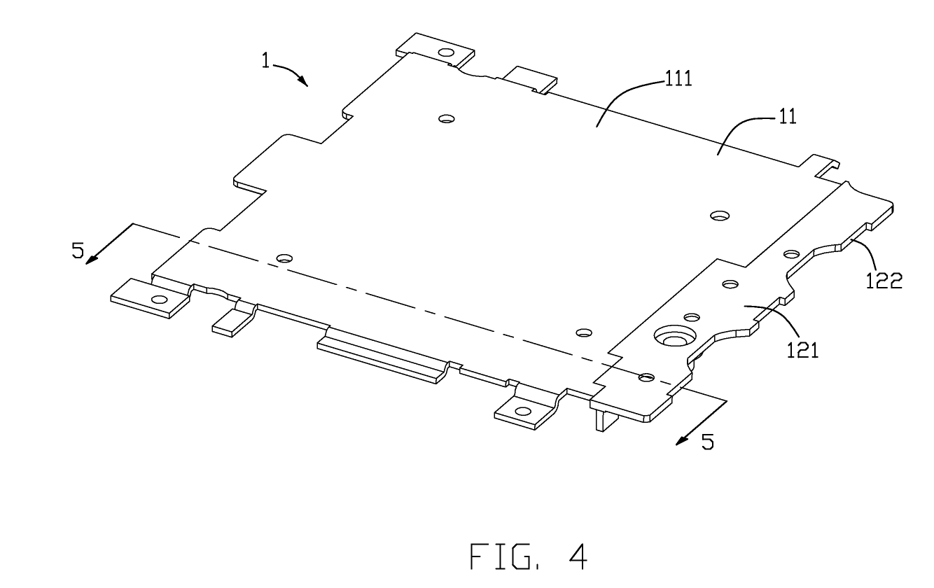

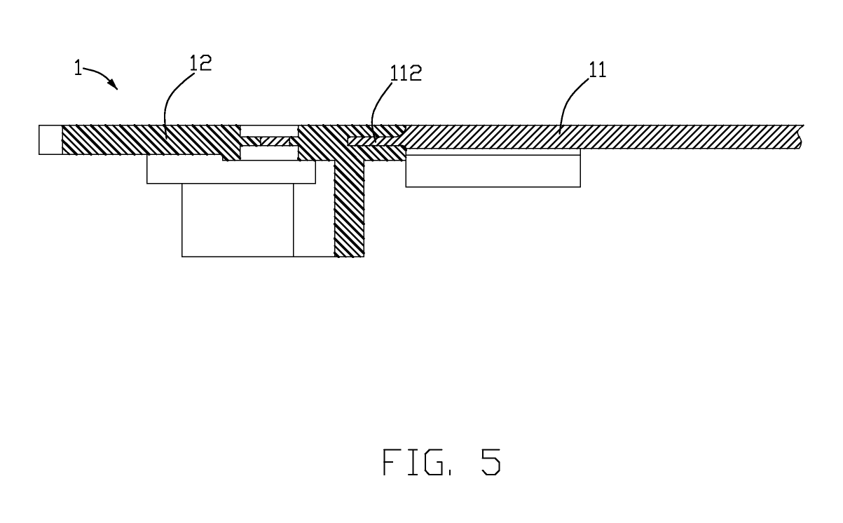

In FIGS. 4 and 5, during the process of assembly, the insulative body 12 engages with the metal body 11 by insert-molding. The retaining tab 112 is thinner than the base portion 111 of the metal body 11 so that the retaining tabs 112 of the metal body 11 can be embedded into the insulative body 12 from one side edge of the insulative body 12 to get a firmly engagement therebetween. Meanwhile, the first sustaining surface 114 of the metal body 11 and the second sustaining surface 121 of the insulative body 12 are coplanar with each other, which provides a smoothness surface for sustaining the keyboard 2. Said retaining tab 112 is formed in a trapezium shape in the parallel plane and has a first end connected with the base portion 111 and a second end wider than the first end for engaging with said insulative body 12. The retaining hole 116 of the retaining tab 112 is be filled with liquid insulative in order to enforce the engagement between the insulative body 12 and the metal body 11.

The retaining tab 112 is formed thinner than the base portion 111 so that the engagement between the metal body 11 and the insulative body 12 can still use the method of insert-molding to get a firmly connection therebetween. Meanwhile, the first sustaining surface 114 and the second sustaining surface 121 can be located in a same plane to make sure the keyboard 2 is sustained stably without any invalid connection between the key buttons and the sustainer 1.

However, while the preferred embodiment of the invention have been shown and described, it will apparent to those skilled in the art that changes and modifications may be made therein without departing from the spirit of the invention, the scope of which is defined by the appended claims.

What is claimed is:

1. A keyboard sustainer comprising:
a metal body having a base portion with a first sustaining surface thereon for sustaining the a keyboard;
an insulative body engaged with the metal body and defining a second sustaining surface for sustaining the keyboard; wherein
said metal body includes a plurality of retaining tabs extending from a side edge of the base portion for being embedded in the insulative body, said first sustaining surface is coplanar with said second sustaining surface.

2. The keyboard sustainer as claimed in claim 1, wherein said retaining tabs are formed lower than the first sustaining surface of the base portion.

3. The keyboard sustainer as claimed in claim 1, wherein said retaining tabs are formed in trapezium and thinner than the base portion in a vertical direction.

4. The keyboard sustainer as claimed in claim 3, wherein said retaining tab further includes a first end connected with the base portion and a second end wider than the first end for engaging with the insulative body.

5. The keyboard sustainer as claimed in claim 4, wherein said second end of the retaining tab is embedded into the insulative body by insert-molding.

6. The keyboard sustainer as claimed in claim 5, wherein the base portion of the metal body further includes a plurality of standoffs formed on a lateral side thereof.

7. The keyboard sustainer as claimed in claim 1, wherein the insulative body engages with the retaining tabs by insert-molding.

8. The keyboard sustainer as claimed in claim 7, wherein said retaining tab has a top surface lower than the first sustaining surface and a retaining hole running through the top surface vertically.

9. The keyboard sustainer as claimed in claim 8, wherein the insulative body has a retaining post protruding downwardly from a bottom surface thereof.

10. The keyboard sustainer as claimed in claim 9, wherein the keyboard sustainer is used to be assembled into a mobile phone by the engagement between the retaining post and a shell frame of the mobile phone.

11. A keyboard sustainer comprising:
a metal body defining a main plane with thereon a first face facing in a first direction;
a retaining tab extending outwardly on at least one edge of the main body with thereon a second face facing in said direction in an inward offset manner with regard to the first face;
an insulative body assembled upon the metal body via an insert molding procedure; wherein
said insulative body defines a third face facing in said direction and being coplanar with the first face.

12. The keyboard sustainer as claimed in claim 11, wherein said insulative body sandwiches said retaining tab.

13. The keyboard sustainer as claimed in claim 12, wherein said retaining tab defines a through hole which the insulative body extends through.

14. The keyboard sustainer as claimed in claim 11, wherein said insulative body defines a sink hole to upwardly expose an edge region of the retaining tab.
